(19) United States
(12) Patent Application Publication
(10) Pub. No.: US 2016/0092287 A1
(43) Pub. Date: Mar. 31, 2016

(54) EVIDENCE-BASED REPLACEMENT OF STORAGE NODES

(71) Applicant: Intel Corporation, Santa Clara, CA (US)

(72) Inventors: ARIJIT BISWAS, Holden, MA (US); STEPHEN A. RACUNAS, Woodside, CA (US); ROBERT F. KWASNICK, Palo Alto, CA (US)

(73) Assignee: Intel Corporation, Santa Clara, CA (US)

(21) Appl. No.: 14/498,641

(22) Filed: Sep. 26, 2014

(51) Int. Cl. G06F 11/07

(52) U.S. Cl. CPC G06F 11/079; G06F 11/0727; G06F 11/076; G06F 11/0787

(57) ABSTRACT

Apparatus, systems, and methods for Recovery algorithm in memory are described. In one embodiment, a controller comprises logic to receive reliability information from at least one component of a storage device coupled to the controller, store the reliability information in a memory communicatively coupled to the controller, generate at least one reliability indicator for the storage device, and forward the reliability indicator to an election module. Other embodiments are also disclosed and claimed.

### TECHNICAL FIELD

The present disclosure generally relates to the field of electronics.

More particularly, some embodiments of the invention generally relate to evidence-based failover of storage nodes for electronic devices, e.g. in network-based storage systems.

### BACKGROUND

Storage servers, in both data centers and in cloud-based deployments, are commonly configured with multiple storage nodes, one of which functions as a primary storage node and two or more of which function as secondary storage nodes. In the event of a failure in the primary storage node one of the secondary storage nodes assumes the role of the primary storage node, a process commonly referred to as “failover” in the industry.

Some existing failover procedures utilize an election process to choose which node will assume the role of the primary node. This election process is performed without regard to the reliability of a potential successor which may result in spurious subsequent failovers and system instability.

Accordingly, techniques to improve failover processes in storage servers may find utility.

### BRIEF DESCRIPTION OF THE DRAWINGS

The detailed description is provided with reference to the accompanying figures. The use of the same reference numbers in different figures indicates similar or identical items.

FIG. 1 is a schematic, block diagram illustration of a networked environment in which evidence-based replacement of storage nodes may be implemented in accordance with various examples discussed herein.

FIG. 2 is a schematic, block diagram illustration of a memory architecture in which evidence-based replacement of storage nodes may be implemented in accordance with various examples discussed herein.

FIG. 3 is a schematic, block diagram illustrating an architecture in which evidence-based replacement of storage nodes may be implemented in accordance with various examples discussed herein.

FIG. 4 is a schematic, block diagram illustrating an architecture for an electronic device in which evidence-based replacement of storage nodes may be implemented in accordance with various examples discussed herein.

FIG. 5 is a flowchart illustrating operations in a method to implement evidence-based replacement of storage nodes in accordance with various embodiments discussed herein.

FIGS. 6-10 are schematic, block diagram illustrations of electronic devices which may be adapted to implement evidence-based replacement of storage nodes in accordance with various embodiments discussed herein.

### DESCRIPTION OF EMBODIMENTS

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

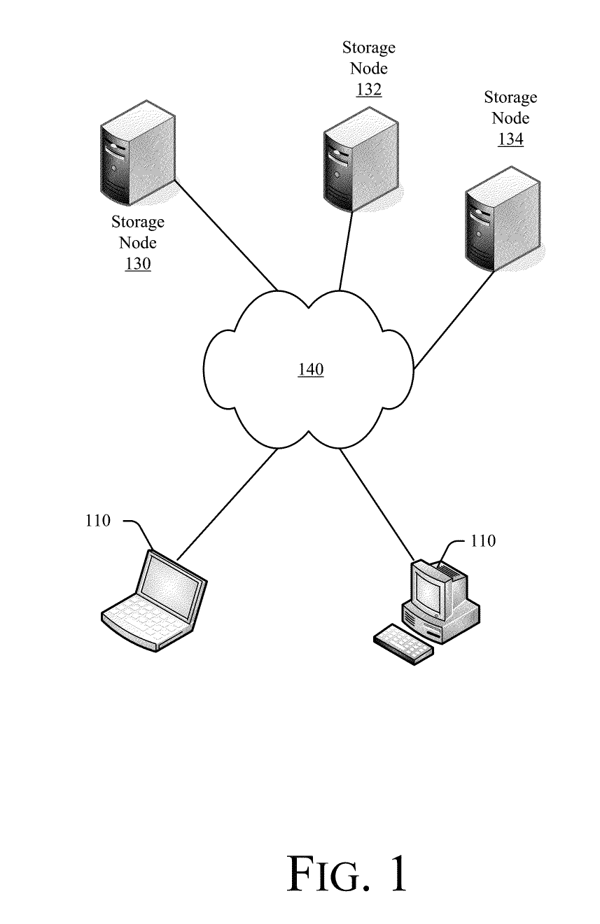

FIG. 1 is a schematic, block diagram illustration of a networked environment in which evidence-based replacement of storage nodes may be implemented in accordance with various examples discussed herein. Referring to FIG. 1, an electronic device(s) 110 may be coupled to one or more storage nodes 130, 132, 134 via a network 140. In some embodiments electronic device (s) 110 may be embodied as a mobile telephone, tablet, PDA or other mobile computing device as described with reference to electronic device(s) 110, below. Network 140 may be embodied as a public communication network such as, e.g., the interne, or as a private communication network, or combinations thereof.

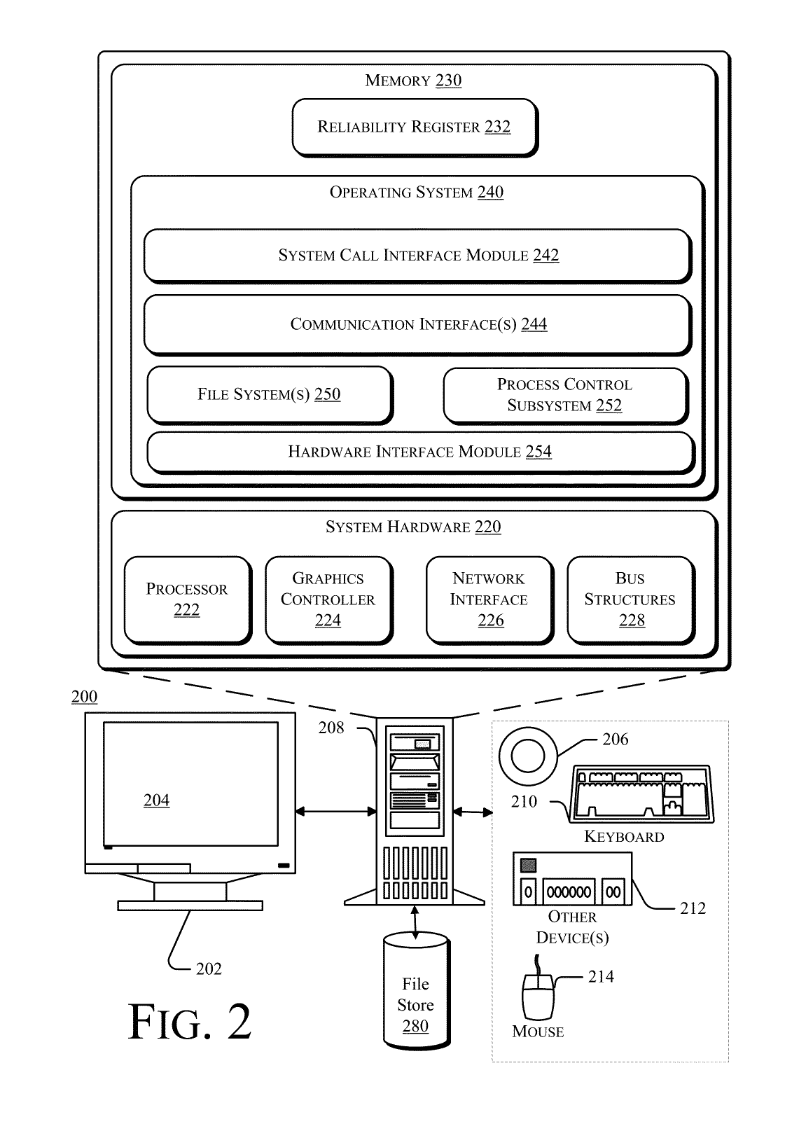

Storage nodes 130, 132, 134 may be embodied as computer-based storage systems. FIG. 2 is a schematic illustration of a computer-based storage system 200 that may be used to implement storage nodes 130, 132, or 134. In some embodiments, system 200 includes a computing device 208 and one or more accompanying input/output devices including a display 202 having a screen 204, one or more speakers 206, a keyboard 210, one or more other I/O device(s) 212, and a mouse 214. The other I/O device(s) 212 may include a touch screen, a voice-activated input device, a track ball, and any other device that allows the system 200 to receive input from a user.

The computing device 208 includes system hardware 220 and memory 230, which may be implemented as random access memory and/or read-only memory. A file store 280 may be communicatively coupled to computing device 208. File store 280 may be internal to computing device 208 such as, e.g., one or more hard drives, CD-ROM drives, DVD-ROM drives, or other types of storage devices. File store 280 may also be external to computer 208 such as, e.g., one or more external hard drives, network attached storage, or a separate storage network.

System hardware 220 may include one or more processors 222, video controllers 224, network interfaces 226, and bus structures 228. In one embodiment, processor 222 may be embodied as an Intel ® Pentium we processor, or an Intel Itanium® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics controller 224 may function as an adjunction processor that manages graphics and/or video operations. Graphics controller 224 may be integrated onto the motherboard of computing system 200 or may be coupled via an expansion slot on the motherboard.

In one embodiment, network interface 226 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN--Part II: Wireless LAN Medium Access Control (MAC) and Physical Layer (PHY) specifications Amendment 4: Further Higher Data Rate Extension in the 2.4 GHz Band, 802.11G-2003).

Bus structures 228 connect various components of system hardware 228. In one embodiment, bus structures 228 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 230 may include an operating system 240 for managing operations of computing device 208. Memory 230 may include a reliability register 232 to which may be used to store reliability information collected during operation of electronic device 200. In one embodiment, operating system 240 includes a hardware interface module 254 that provides an interface to system hardware 220. In addition, operating system 240 may include a file system 250 that manages files used in the operation of computing device 208 and a process control subsystem 252 that manages processes executing on computing device 208.

Operating system 240 may include (or manage) one or more communication interfaces that may operate in conjunction with system hardware 220 to transceive data packets and/or data streams from a remote source. Operating system 240 may further include a system call interface module 242 that provides an interface between the operating system 240 and one or more application modules resident in memory 230. Operating system 240 may be embodied as a UNIX operating system or any derivative thereof (e.g., Linux, Solaris, etc.) or as a Windows® brand operating system, or other operating systems.

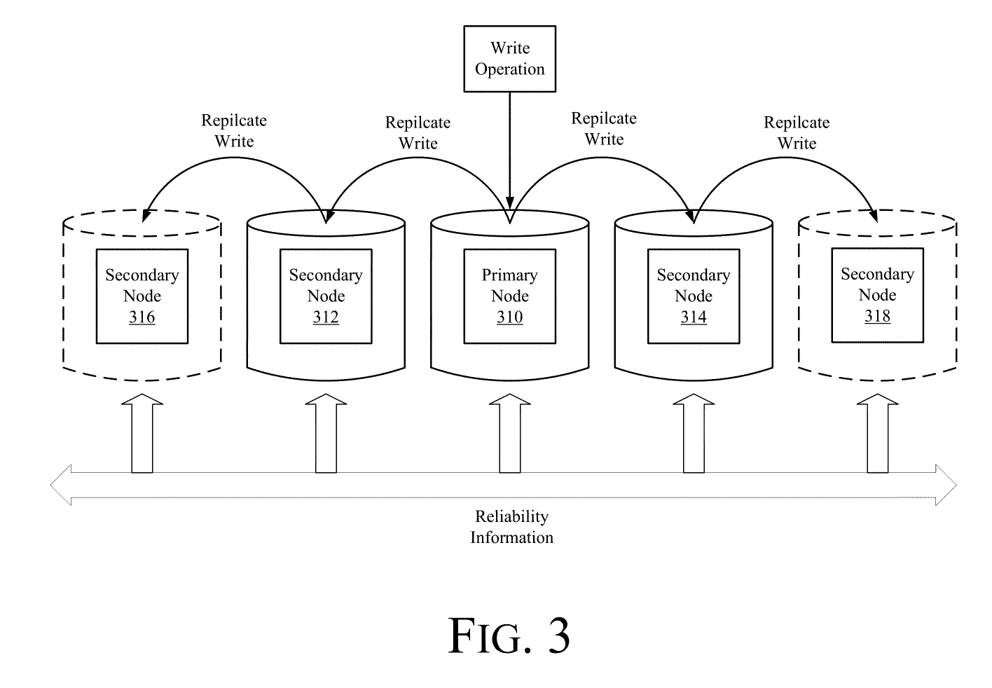

FIG. 3 is a schematic, block diagram illustrating an architecture in which evidence-based replacement of storage nodes may be implemented in accordance with various examples discussed herein. In some examples, the storage nodes may be divided into a primary storage node and two or more secondary storage nodes. In the example depicted in FIG. 3, the storage nodes are divided into a primary storage node 310 and two secondary storage nodes 312, 314. In operation, write operations from a host device are received in the primary node 310. The write operations are then replicated from the primary node 310 to the secondary nodes 312, 314. One skilled in the art will recognize that additional secondary nodes could be added. The example depicted in FIG. 3 depicts two additional secondary nodes 316, 318.

In some examples one or more of the storage nodes 130, 132, 134 may incorporate one or more reliability monitors which receive reliability information from at least one component of a storage device (e.g., a disk drive, solid state drive, RAID array, dual in-line memory module (DIMM), or the like) in the storage node and a reliability monitoring engine which receives reliability information collected by the reliability monitor(s) and generates one or more reliability indicators for the storage node(s) 130, 132, 134 from the reliability information. The reliability indicator(s) may then be incorporated into an election process for a failover routine.

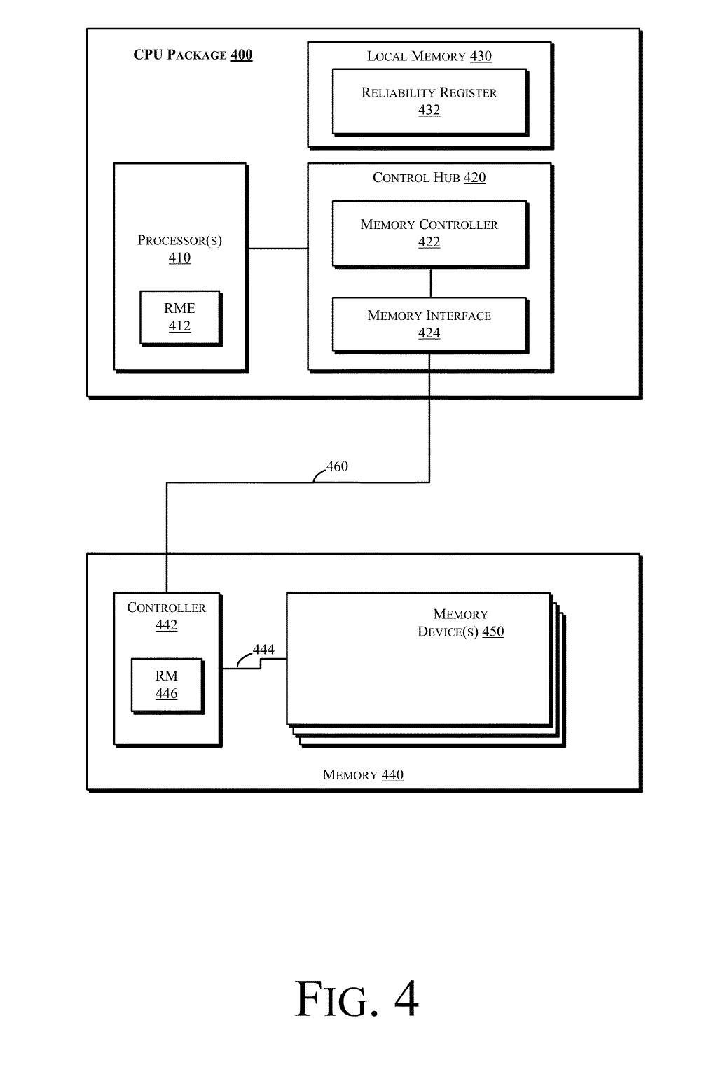

FIG. 4 is a schematic, block diagram illustrating an architecture for an electronic device in which evidence-based replacement of storage nodes may be implemented in accordance with various examples discussed herein. Referring to FIG. 4, in some embodiments a central processing unit (CPU) package 400 which may comprise one or more processors 410 coupled to a control hub 420 and a local memory 430. Control hub 420 comprises a memory controller 422 and a memory interface 424. Local memory 430 may include a reliability register 432 analogous to register 232 may be used to store reliability information collected during operation of electronic device 400. In some examples the reliability register may be implemented in non-volatile hardware registers.

Memory interface 424 is coupled to a remote memory 440 by a communication bus 460. In some examples, the communication bus 460 may be implemented as traces on a printed circuit board, a cable with copper wires, a fiber optic cable, a connecting socket, or a combination of the above. Memory 440 may comprise a controller 442 and one or more memory device(s) 450. In various embodiments, at least some of the memory banks 450 may be implemented using volatile memory, e.g., static random access memory (SRAM), a dynamic random access memory (DRAM), nonvolatile memory, or non-volatile memory, e.g., phase change memory, NAND (flash) memory, ferroelectric random-access memory (FeRAM), nanowire-based non-volatile memory, memory that incorporates memristor technology, three dimensional (3D) cross point memory such as phase change memory (PCM), spin-transfer torque memory (STT-RAM) or NAND flash memory. The specific configuration of the memory device(s) 450 in the memory 440 is not critical.

In the example depicted in FIG. 4 a reliability monitor (RM) logic 446 is incorporated into controller 446. Similarly, reliability monitoring engine (RME) logic 412 is incorporated into processor(s) 410. In operation, the reliability monitor(s) 446 and the reliability monitoring engine 412 cooperate to collect reliability information from various components of the electronic device and to generate at least one reliability indicator for the electronic device.

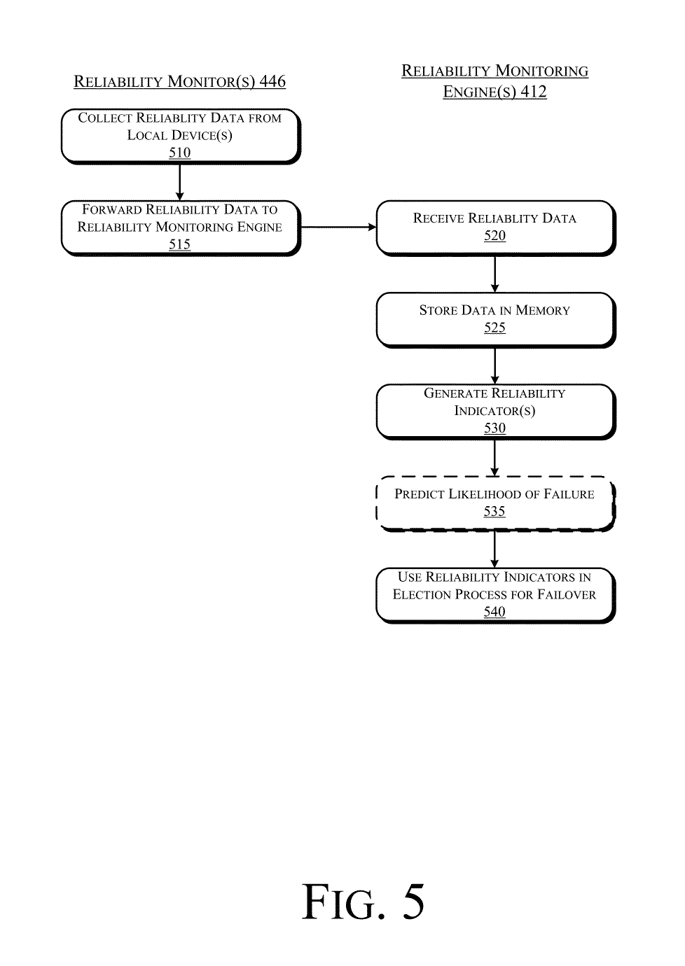

One example of a method for evidence-based elective replacement of storage nodes for electronic devices will be described with reference to FIGS. 4 and 5. Referring to FIG. 5, at operation 510 one or more of the reliability monitors 446 may collect reliability information including, but not limited to a failure count (or failure rate) for the storage device, or a failure count (or failure rate) for the storage device. As used herein, the term “fault” refers to any type of fault event for the storage device including read or write errors in the memory of the storage device or hardware errors in components of the storage device. The term “failure” refers to a fault which affects the proper functioning of the storage device.

The reliability monitor 446 may also collect information pertaining to an amount of time the storage device spent in a turbo mode or an amount of time the storage device spent in an idle mode. As used herein the phrase “turbo mode” refers to an operating mode in which the device increases the voltage and/or operating frequency when there is power available and sufficient thermal headroom available to support an increase in operating speed. By contrast the phrase “idle mode” refers to an operating mode in which voltage and/or operating speed are reduced during time periods in which the storage device is not being utilized.

The reliability monitor 446 may also collect information pertaining to voltage information for the storage device. For example, the reliability monitor 446 may collect an amount of time spent at high voltage (i.e., Vmax), an amount of time spent at low voltages (Vmin), and voltage excursions such as a change in current flow over a change in time (dI/dT) events, voltage histograms, average voltage over predetermined periods of time, etc.

The reliability monitor 446 may also collect temperature information for the storage device. Examples of temperature information may include the maximum temperature, minimum temperature, and average temperature over specified periods of time, temperature cycling information (e.g., min/max and average temperature over very short periods of time). Temperature differentials beyond a certain threshold—can be indicators of thermal stress

In other examples information from machine check registers that log corrected and uncorrected error information from all over the chip may be used to determine whether a system has experienced high frequencies of corrected or uncorrected errors as another potential indication of reliability issues. Corrected and uncorrected error information for storage device can include error correction code (ECC) corrected/detected errors, errors detected on solid state drives (SSDs), cyclical redundancy code (CRC) checks or the like.

In further examples voltage/thermal sensors may be used to monitor for voltage droop, i.e., the drop in output voltage as it drives a load. Voltage droop phenomenon can result in timing delays and speed paths which can result in functional failure/incorrect output (i.e., errors). Circuits are designed to factor in a certain amount of droop, and robust circuits and power delivery systems mitigate or tolerate a certain amount of droop. However, certain data patterns or patterns of simultaneous or concurrent activity can create droop events beyond the tolerance levels designed and result in problems. Monitoring droop event characteristics such as amplitude and duration may impart information relevant to the reliability of a component.

At operation 515, the reliability data collected by the reliability monitor(s) 446 is forwarded to the reliability monitoring engine 412, e.g., via the communication bus 460.

At operation 520 the reliability monitoring engine 412 receives the reliability data from the reliability monitor(s) 446 and at operation 525 the data is stored in a memory, e.g., in local memory 430.

At operation 530 the reliability monitoring engine 412 generates one or more reliability indicators for the storage device(s) using the reliability information received from the reliability monitor(s) 446. In some examples the reliability monitoring engine 412 may apply a weighting factor to one or more elements of the reliability information. For example, fault events may be assigned a higher weight than failure events. Optionally, at operation 535 the reliability monitoring engine(s) 412 may predict a likelihood of failure for the storage device 130, 132, 134 using the reliability storage.

At operation 540 one or more of the reliability indicators are used in an election process for a failover routine. For example, referring to FIG. 3, in some examples reliability indicators may be exchanged between nodes or may be shared with a remote device, e.g., a server. During a failover process in which the primary node 310 is taken offline or otherwise becomes the secondary node, the reliability indicators may be used in an election process to determine which of the secondary nodes 312, 314, 316, 318 will assume the role of the primary node.

Since much of the reliability data is accumulated over time, a single failure, or even periodic reliability issues in the actual detection hardware will not materially affect the final cumulative assessment of the component. Rather, such issues may show up as anomalies in the various reliability detection mechanisms. The selection algorithm may use a combination of evaluations from each of these sources to determine the most reliable system. This combination can be done in a complex fashion taking into account magnitudes of anomalies as well as frequencies of issues observed, hysteresis of degradation trends and the like, or can simply be a weighted average of the most recent accumulated behavior weighted based on system defaults or user preference as to which reliability issues should be deemed worse than others.

In some examples, each secondary node 312, 314, 316, 318 may query the reliability information from for all other secondary nodes 312, 314, 316, 318 and independently determine the most reliable secondary node 312, 314, 316, 318 available. As long as this algorithm is the same on each secondary node 312, 314, 316, 318, each secondary node 312, 314, 316, 318 should independently select the same secondary node 312, 314, 316, 318 as being the best, most reliable candidate for election to assume the role of the new primary node. In the case of an error or fault in the selection algorithm on any one secondary node 312, 314, 316, 318, a majority voting scheme may be employed such that the secondary node 312, 314, 316, 318 chosen by the majority of the pool as being the most reliable would be the one selected as the new primary node.

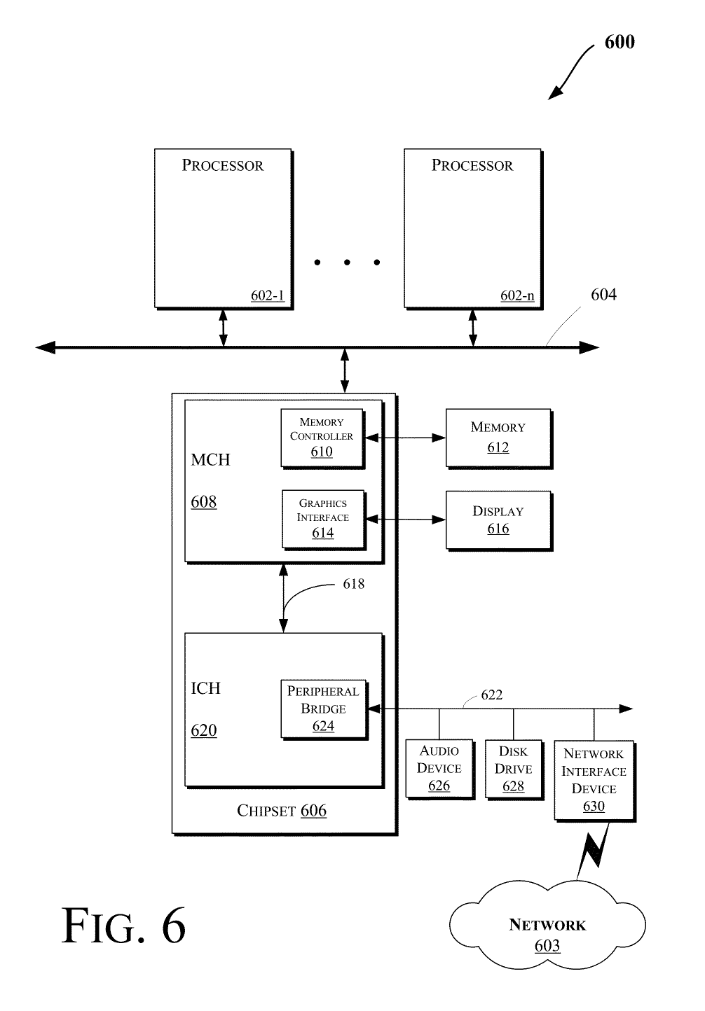

As described above, in some embodiments the electronic device may be embodied as a computer system. FIG. 6 illustrates a block diagram of a computing system 600 in accordance with an embodiment of the invention. The computing system 600 may include one or more central processing unit(s) (CPUs) 602 or processors that communicate via an interconnection network (or bus) 604. The processors 602 may include a general purpose processor, a network processor (that processes storage communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an embodiment, one or more of the processors 602 may be the same or similar to the processorors 102 of FIG. 1. For example, one or more of the processors 602 may include the control unit 120 discussed with reference to FIGS. 1-3. Also, the operations discussed with reference to FIGS. 3-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612 (which may be the same or similar to the memory 130 of FIG. 1). The memory 412 may store data, including sequences of instructions, that may be executed by the CPU 602, or any other device included in the computing system 600. In one embodiment of the invention, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk or a solid state drive (SSD). Additional devices may communicate via the interconnection network 604, such as multiple CPUs and/or multiple system memories.

The MCH 608 may also include a graphics interface 614 that communicates with a display device 616. In one embodiment of the invention, the graphics interface 614 may communicate with the display device 616 via an accelerated graphics port (AGP). In an embodiment of the invention, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the CPU 602 and peripheral devices. Other types of topologies may be utilized. Also, multiple buses may communicate with the ICH 620, e.g., through multiple bridges or controllers. Moreover, other peripherals in communication with the ICH 620 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some embodiments of the invention. In addition, the processor 602 and one or more other components discussed herein may be combined to form a single chip (e.g., to provide a System on Chip (SOC)). Furthermore, the graphics accelerator 616 may be included within the MCH 608 in other embodiments of the invention.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic storage (e.g., including instructions).

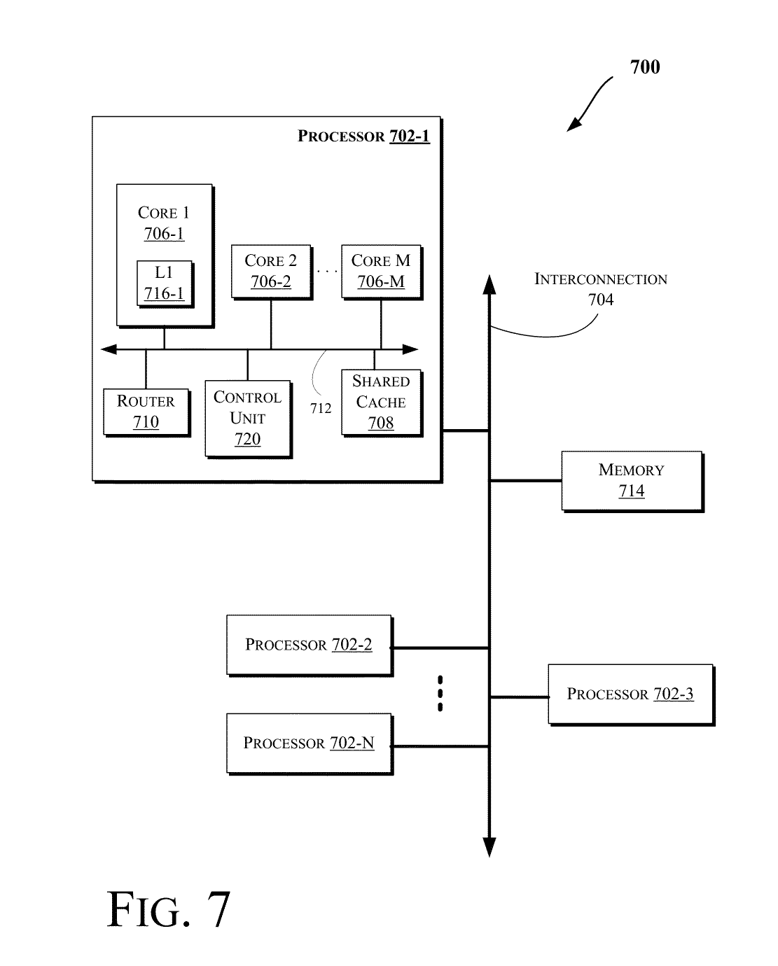

FIG. 7 illustrates a block diagram of a computing system 700, according to an embodiment of the invention. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an embodiment, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one embodiment, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an embodiment, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some embodiments, one or more of the cores 706 may include a level 1 (L1) cache 716-1 (generally referred to herein as “L1 cache 716”). In one embodiment, the control unit 720 may include logic to implement the operations described above with reference to the memory controller 122 in FIG. 2.

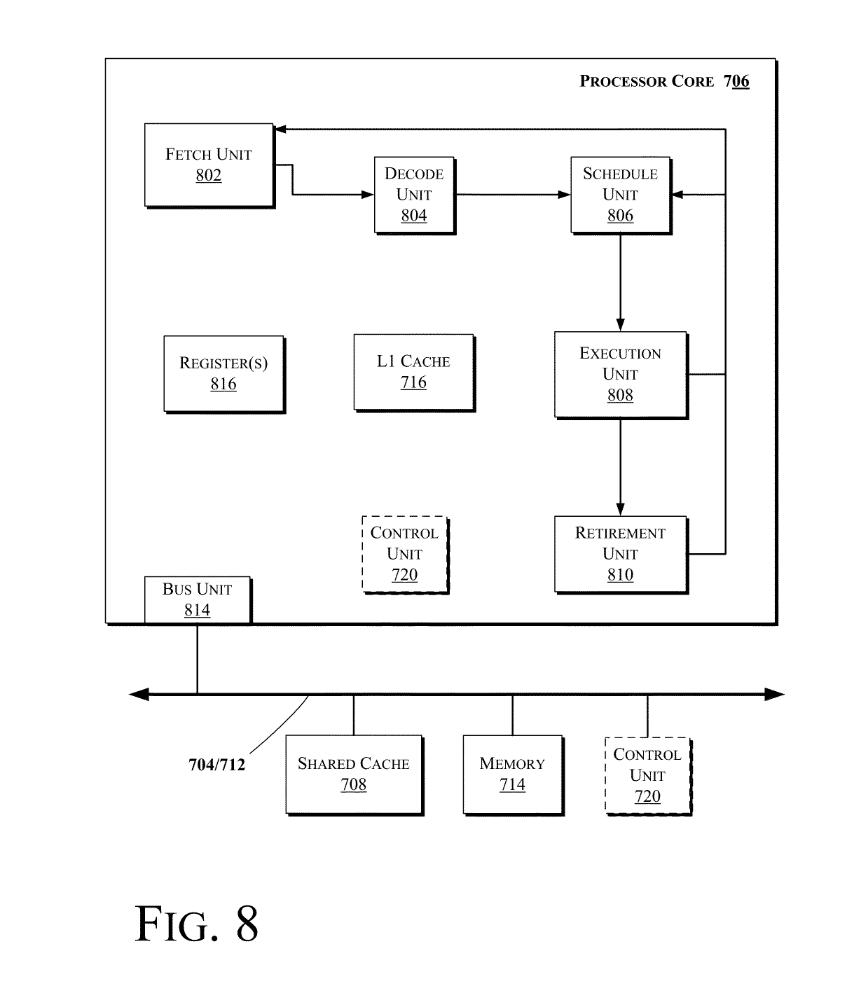

FIG. 8 illustrates a block diagram of portions of a processor core 706 and other components of a computing system, according to an embodiment of the invention. In one embodiment, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one embodiment, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an embodiment, the execution unit 808 may include more than one execution unit. The execution unit 808 may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit 808.

Further, the execution unit 808 may execute instructions out-of-order. Hence, the processor core 706 may be an out-of-order processor core in one embodiment. The core 706 may also include a retirement unit 810. The retirement unit 810 may retire executed instructions after they are committed. In an embodiment, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various embodiments the control unit 720 may be located elsewhere such as inside the core 706, coupled to the core via bus 704, etc.

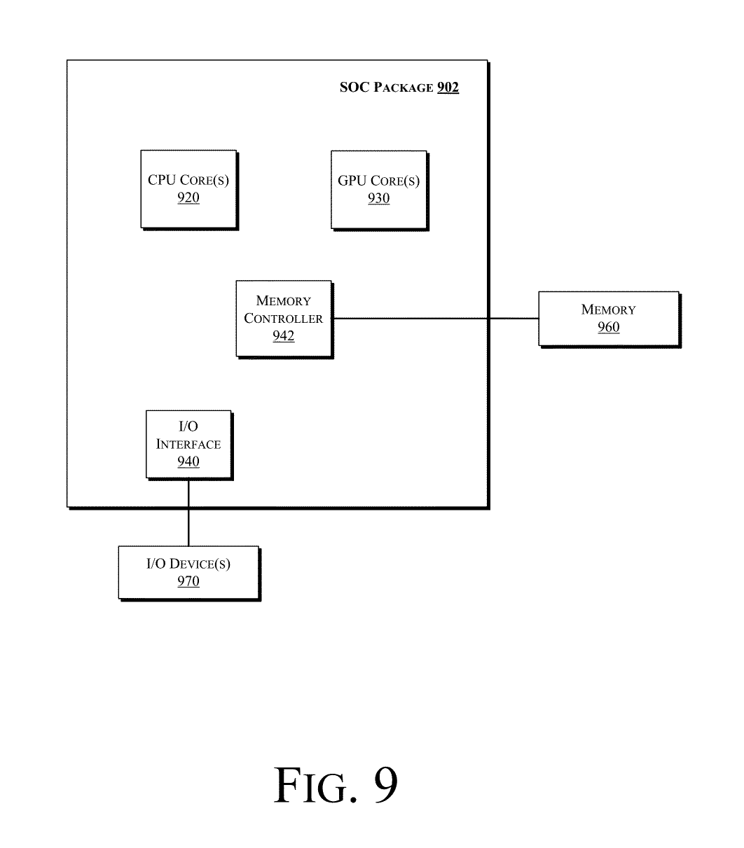

In some embodiments, one or more of the components discussed herein can be embodied as a System On Chip (SOC) device. FIG. 9 illustrates a block diagram of an SOC package in accordance with an embodiment. As illustrated in FIG. 9, SOC 902 includes one or more Central Processing Unit (CPU) cores 920, one or more Graphics Processor Unit (GPU) cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one embodiment, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an embodiment, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch screen, a speaker, or the like.

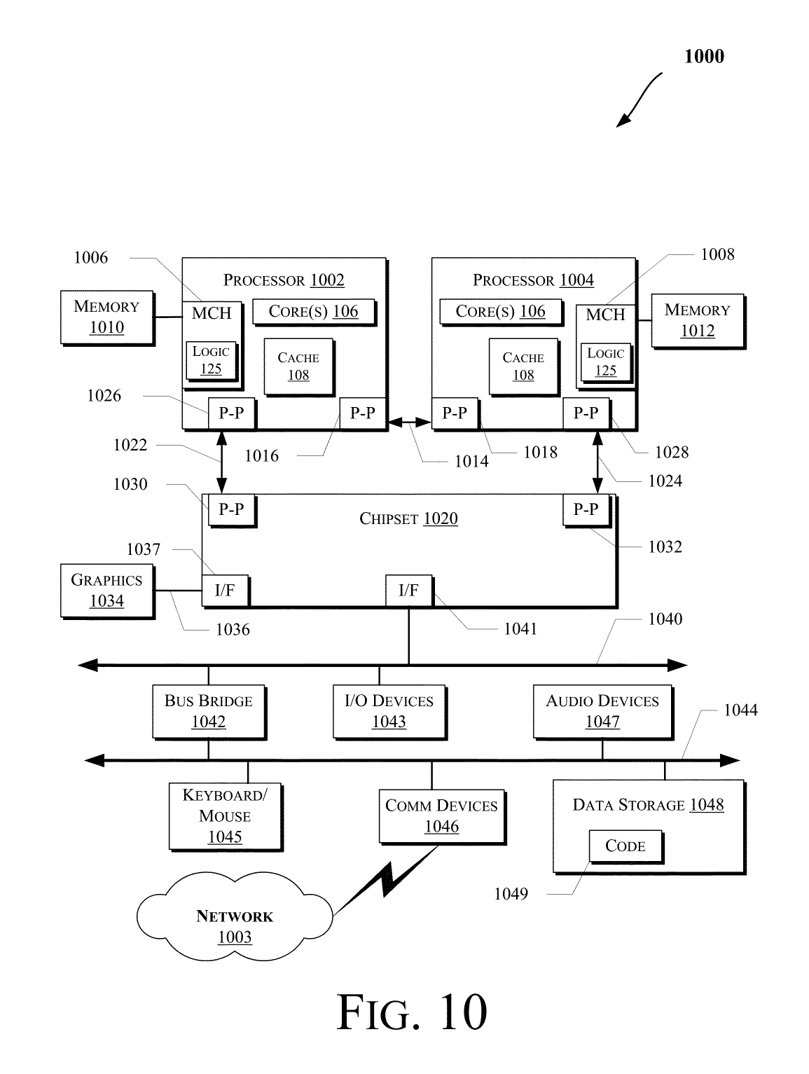

FIG. 10 illustrates a computing system 1000 that is arranged in a point-to-point (PtP) configuration, according to an embodiment of the invention. In particular, FIG. 10 shows a system where processors, memory, and input/output devices are interconnected by a number of point-to-point interfaces. The operations discussed with reference to FIG. 2 may be performed by one or more components of the system 1000.

As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012. MCH 1006 and 1008 may include the memory controller 120 and/or logic 125 of FIG. 1 in some embodiments.

In an embodiment, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

As shown in FIG. 10, one or more of the cores 106 and/or cache 108 of FIG. 1 may be located within the processors 902 and 904. Other embodiments of the invention, however, may exist in other circuits, logic units, or devices within the system 900 of FIG. 9. Furthermore, other embodiments of the invention may be distributed throughout several circuits, logic units, or devices illustrated in FIG. 9.

The chipset 920 may communicate with a bus 940 using a PtP interface circuit 941. The bus 940 may have one or more devices that communicate with it, such as a bus bridge 942 and I/O devices 943. Via a bus 944, the bus bridge 943 may communicate with other devices such as a keyboard/mouse 945, communication devices 946 (such as modems, network interface devices, or other communication devices that may communicate with the computer network 803), audio I/O device, and/or a storage storage device 948. The storage storage device 948 (which may be a hard disk drive or a NAND flash based solid state drive) may store code 949 that may be executed by the processors 902 and/or 904.

The following examples pertain to further embodiments.

Example 1 is a controller comprising logic, at least partially including hardware logic, configured to receive reliability information from at least one component of a storage device coupled to the controller, store the reliability information in a memory communicatively coupled to the controller, generate at least one reliability indicator for the storage device, and forward the reliability indicator to an election module.

In Example 2, the subject matter of Example 1 can optionally include an arrangement in which the reliability information includes at least one of a failure count for the storage device, a failure rate for the storage device, an error rate for the storage device, an amount of time the storage device spent in a turbo mode, an amount of time the storage device spent in an idle mode, voltage information for the storage device, or temperature information for the storage device

In Example 3, the subject matter of any one of Examples 1-2 can optionally include an arrangement in which the logic to generate a reliability indicator for the storage device further comprises logic to apply a weighting factor to the reliability information.

In Example 4, the subject matter of any one of Examples 1-3 can optionally include logic to predict a likelihood of failure based upon the reliability information.

In Example 5, the subject matter of any one of Examples 1-4 can optionally include an arrangement in which the election module comprises logic to receive the reliability indicator and use the reliability indicator in an election process to select a primary storage node candidate from a plurality of secondary storage nodes.

Example 6 is an electronic device comprising a processor and a memory, comprising a memory device and a controller coupled to the memory device and comprising logic to receive reliability information from at least one component of a storage device coupled to the controller, store the reliability information in a memory communicatively coupled to the controller, generate at least one reliability indicator for the storage device, and forward the reliability indicator to an election module.

In Example 7, the subject matter of Example 6 can optionally include an arrangement in which the reliability information includes at least one of a failure count for the storage device, a failure rate for the storage device, an error rate for the storage device, an amount of time the storage device spent in a turbo mode, an amount of time the storage device spent in an idle mode, voltage information for the storage device, or temperature information for the storage device

In Example 8, the subject matter of any one of Examples 6-7 can optionally include an arrangement in which the logic to generate a reliability indicator for the storage device further comprises logic to apply a weighting factor to the reliability information.

In Example 9, the subject matter of any one of Examples 6-8 can optionally include logic to predict a likelihood of failure based upon the reliability information.

In Example 10, the subject matter of any one of Examples 6-9 can optionally include an arrangement in which the election module comprises logic to receive the reliability indicator and use the reliability indicator in an election process to select a primary storage node candidate from a plurality of secondary storage nodes.

Example 11 is a computer program product comprising logic instructions stored on a nontransitory computer readable medium which, when executed by a controller coupled to a memory device, configure the controller to receive reliability information from at least one component of a storage device coupled to the controller, store the reliability information in a memory communicatively coupled to the controller, generate at least one reliability indicator for the storage device, and forward the reliability indicator to an election module.

In Example 12, the subject matter of Example 11 can optionally include an arrangement in which the reliability information includes at least one of a failure count for the storage device, a failure rate for the storage device, an error rate for the storage device, an amount of time the storage device spent in a turbo mode, an amount of time the storage device spent in an idle mode, voltage information for the storage device, or temperature information for the storage device

In Example 13, the subject matter of any one of Examples 11-12 can optionally include an arrangement in which the logic to generate a reliability indicator for the storage device further comprises logic to apply a weighting factor to the reliability information.

In Example 14, the subject matter of any one of Examples 11-13 can optionally include logic to predict a likelihood of failure based upon the reliability information.

In Example 15, the subject matter of any one of Examples 11-14 can optionally include an arrangement in which the election module comprises logic to receive the reliability indicator and use the reliability indicator in an election process to select a primary storage node candidate from a plurality of secondary storage nodes.

Example 16 is a controller-implemented method comprising receiving reliability information from at least one component of a storage device coupled to the controller, storing the reliability information in a memory communicatively coupled to the controller, generate at least one reliability indicator for the storage device, and forwarding the reliability indicator to an election module.

In Example 17, the subject matter of Example 16 can optionally include an arrangement in which the reliability information includes at least one of a failure count for the storage device, a failure rate for the storage device, an error rate for the storage device, an amount of time the storage device spent in a turbo mode, an amount of time the storage device spent in an idle mode, voltage information for the storage device, or temperature information for the storage device

In Example 18, the subject matter of any one of Examples 16-17 can optionally include applying a weighting factor to the reliability information.

In Example 19, the subject matter of any one of Examples 16-18 can optionally include predicting a likelihood of failure based upon the reliability information.

In Example 20, the subject matter of any one of Examples 16-19 can optionally include selecting a primary storage node candidate from a plurality of secondary storage nodes.

In various embodiments of the invention, the operations discussed herein, e.g., with reference to FIGS. 1-10, may be implemented as hardware (e.g., circuitry), software, firmware, microcode, or combinations thereof, which may be provided as a computer program product, e.g., including a tangible (e.g., non-transitory) machine-readable or computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed herein.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. A controller comprising logic, at least partially including hardware logic, configured to:
receive reliability information from at least one component of a storage device coupled to the controller;
store the reliability information in a memory communicatively coupled to the controller;
generate at least one reliability indicator for the storage device; and
forward the reliability indicator to an election module.

2. The controller of claim 1, wherein the reliability information includes at least one of:
a failure count for the storage device;
a failure rate for the storage device;
an error rate for the storage device;
an amount of time the storage device spent in a turbo mode;
an amount of time the storage device spent in an idle mode
voltage information for the storage device; or
temperature information for the storage device.

3. The controller of claim 2, wherein the logic to generate a reliability indicator for the storage device further comprises logic to:
apply a weighting factor to the reliability information.

4. The controller of claim 2, wherein the logic to generate a reliability indicator for the storage device further comprises logic to:
predict a likelihood of failure based upon the reliability information.

5. The controller of claim 1, wherein the election module comprises logic to:
receive the reliability indicator; and
use the reliability indicator in an election process to select a primary storage node candidate from a plurality of secondary storage nodes.

6. An electronic device, comprising:
a processor; and
a memory, comprising:
a memory device; and
a controller coupled to the memory device and comprising logic to:
receive reliability information from at least one component of a storage device coupled to the controller;
store the reliability information in a memory communicatively coupled to the controller;
generate at least one reliability indicator for the storage device; and
forward the reliability indicator to an election module.

7. The electronic device of claim 8, wherein the reliability information includes at least one of:
a failure count for the storage device;
a failure rate for the storage device;
an error rate for the storage device;
an amount of time the storage device spent in a turbo mode;
an amount of time the storage device spent in an idle mode
voltage information for the storage device; or
temperature information for the storage device.

8. The electronic device of claim 7, wherein the logic to generate a reliability indicator for the storage device further comprises logic to:
apply a weighting factor to the reliability information.

9. The electronic device of claim 7, wherein the logic to generate a reliability indicator for the storage device further comprises logic to:
predict a likelihood of failure based upon the reliability information.

10. The electronic device of claim 6, wherein the election module comprises logic to:
receive the reliability indicator; and
use the reliability indicator in an election process to select a primary storage node candidate from a plurality of secondary storage nodes.

11. A computer program product comprising logic instructions stored on a nontransitory computer readable medium which, when executed by a controller coupled to a memory device, configure the controller to:
receive reliability information from at least one component of a storage device coupled to the controller;
store the reliability information in a memory communicatively coupled to the controller;
generate at least one reliability indicator for the storage device; and
forward the reliability indicator to an election module.

12. The computer program product of claim 11, wherein the reliability information includes at least one of:
a failure count for the storage device;
a failure rate for the storage device;
an error rate for the storage device;
an amount of time the storage device spent in a turbo mode;
an amount of time the storage device spent in an idle mode
voltage information for the storage device; or
temperature information for the storage device.

13. The computer program product of claim 12, wherein the logic to generate a reliability indicator for the storage device further comprises logic to:
apply a weighting factor to the reliability information.

14. The computer program product of claim 12, wherein the logic to generate a reliability indicator for the storage device further comprises logic to:
predict a likelihood of failure based upon the reliability information.

15. The computer program product of claim 11, wherein the election module comprises logic to:
receive the reliability indicator; and
use the reliability indicator in an election process to select a primary storage node candidate from a plurality of secondary storage nodes.

16. A controller-implemented method, comprising:
receiving reliability information from at least one component of a storage device coupled to the controller;
storing the reliability information in a memory communicatively coupled to the controller;
generating at least one reliability indicator for the storage device; and
forwarding the reliability indicator to an election module.

17. The method of claim 16, wherein the reliability information includes at least one of:
a failure count for the storage device;
a failure rate for the storage device;
an error rate for the storage device;
an amount of time the storage device spent in a turbo mode;
an amount of time the storage device spent in an idle mode
voltage information for the storage device; or
temperature information for the storage device.

18. The method of claim 17, further comprising:
applying a weighting factor to the reliability information.

19. The method of claim 17, further comprising:
predicting a likelihood of failure based upon the reliability information.

20. The method of claim 15, further comprising:
receiving the reliability indicator; and
using the reliability indicator in an election process to select a primary storage node candidate from a plurality of secondary storage nodes.
